(19) United States
(12) Patent Application Publication
(10) Pub. No.: US 2006/0055144 A1
(43) Pub. Date: Mar. 16, 2006

(54) Muscle-powered continuously variable drive system and apparatus having same

(76) Inventor: Stephen Norman, Burlington, VT (US)

Correspondence Address: Stephen NORMAN, 96 Staniford Road, Burlington, VT, 05401, US

(21) Appl. No.: 11/176,447

(22) Filed: Jul. 7, 2005

Related U.S. Application Data
(60) Provisional application No. 60/651,483, filed on Sep. 13, 2004.

(51) Int. Cl. B62M 1/08

(52) U.S. Cl. 280/251

(57) ABSTRACT

A muscle-powered continuously variable drive system, and apparatus having same, is disclosed. The system employs dual actuator levers pivoted at one end. The free pedal ends of the levers reciprocate through an arcuate range of motion via application of muscle power by the user, rather than cycling through complete revolutions of a small-radius circle, such as is common for conventional bicycles. The reciprocating motion of the levers initiated by the user generates a force that is translated into rotational motion of a drive wheel via a drive tether. The drive tether is attached to the actuator levers and runs around three idler pulleys mounted to the apparatus' frame. Two chain segments of the tether engage respective dual sprockets at the hub of the drive wheel. The geometry of the transmission enables a light, simple, system of continuously-variable torque multiplication, which eliminates the need for conventional derailleurs and multiple sprockets, or internal gear hubs.

### CLAIM OF PRIORITY

This application claims priority under 35 USC § 119(e) from U.S. Provisional Patent Application No. 60/651,483, filed on Sep. 13, 2004.

### FIELD OF THE INVENTION

The invention relates to muscle-powered drive systems and apparatus having same.

### BACKGROUND ART

There are a number of transportation devices such as bicycles that rely on muscle-power drive systems. Conventional bicycles, for example, have a front chain wheel (“chain ring”) to which pedals are attached. The pedals are arranged to allow a user to drive the front chain wheel by pedaling in cyclical fashion with their feet while sitting atop the bicycle. The front chain ring is mechanically coupled to a rear freewheel by a chain. The rear freewheel is operably arranged at the hub of the rear wheel of the bicycle, and typically has multiple sprockets so that the user can select between different gears. In operation, the user causes his or her legs to exert a downward force on the pedals to initiate a cycling motion. The force is transferred from the chain ring to a sprocket on the rear freewheel to drive the bicycle forward. Front and rear derailleurs allow the user to change gears by shifting the chain between the multiple sprockets at the rear freewheel and/or the front chain ring.

There have been numerous attempts to design other types of muscle-powered drive systems with the object of improving efficiency, such as described in the following U.S. patents: U.S. Pat. No. 6,648,355 B2 to Ridenhour; U.S. Pat. No. 6,554,309 to Thir; U.S. Pat. No. 5,785,337 to Ming; U.S. Pat. No. 5,690,345 to Kiser; U.S. Pat. No. 5,335,927 to Islas; U.S. Pat. No. 4,953,882 to Craig, Jr.; U.S. Pat. No. 4,857,035 to Anderson; U.S. Pat. No. 4,630,839 to Seol; U.S. Pat. No. 4,574,649 to Seol; U.S. Pat. No. 4,272,096 to Efros; U.S. Pat. No. 4,133,550 to Brown; U.S. Pat. No. 4,077,648 to Seol; and U.S. Pat. No. 4,019,230 to Pollard.

Unfortunately, the prior art muscle-power drive systems suffer from excess mechanical complexity, incurring both weight and mechanical efficiency penalties.

### SUMMARY OF THE INVENTION

The invention is directed to a light-weight, mechanically simple, ergonomically efficient muscle-power drive system suitable for use in limb-driven human-powered apparatus and machinery such as bicycles, tricycles, wheel chairs, etc. The ergonomic improvement is achieved in the present invention through a reciprocating-motion design. When used in a bicycle, the drive system of the present invention is believed to make better use of leg muscle power as compared to conventional rotary cranking motion drive systems such as used in a conventional bicycle.

The invention enables the complete elimination of the conventional rotary-pedal bicycle's front, or crank, hub and bearings, with attendant simplification of the frame design and substantial weight savings. The invention also allows for partial-stroke propulsion (i.e., continuous application of power using less-than-full-length strokes), and mass centralization due to the continuously-side-by-side positioning of the rider's legs. Both of these features are particularly advantageous in off-road riding.

Because of the mechanical simplicity of the invention, manufacturing costs are expected to be significantly less than for conventional designs.

An aspect of the invention is a muscle-powered drive system that utilizes right and left pivotable actuator levers. The levers run horizontally along the sides of a frame, which supports a drive wheel. The drive wheel includes an axle and a hub having two mirror-image but otherwise conventional freewheel devices on its right and left sides, incorporating identical right and left drive sprockets. One end of each actuator lever is pivotably mounted to the frame at or near the rear axle, or to the rear axle itself. A tether with two chain sections and three cable sections is attached at respective ends to coupling points along the length of the actuator levers. The location of the coupling points is changeable (movable) via sliding members (“sliders”) that move within respective channels formed along the length of the actuator levers. The tether runs through idler pulleys attached to the frame and also over the right and left sprockets. The idler pulleys are arranged to convert the force associated with alternating up-and-down strokes of the actuator levers into alternating forward rotational forces on the wheel via engagement of the drive tether with the sprockets of the drive wheel.

The actuator levers are pivotably mounted to the frame at or near the axle of the drive wheel. The actuator levers have moveable ends (the pedals, in the preferred embodiment) that travel over a small segment (e.g., about 25 degrees) of a large-radius circular arc, rather than through complete revolutions of a small-radius circle as with conventional rotary-pedal bicycles. When the user engages the levers and moves them in reciprocal fashion, the two levers alternately pull on the two ends of the cable-and-chain tether. The tether runs through the system of idler pulleys and acts alternately on right and left sprockets on the drive wheel hub to power the drive wheel. In an example embodiment, the inertia of the reciprocating mass in the system is captured and returned to the system by torsion springs arranged between the frame and the actuator levers. In an example embodiment, the torsion springs provide a natural period of 70-90 cycles/minute, depending on the user's preference.

The respective positions of the coupling points is adjustable and can range from close to the pivot end of the actuator lever, to close to the pedal surfaces at the end opposite the pivot end. The geometry of the tether and the idler pulleys thereby provides continuously variable lever-travel-to-wheel-travel ratios over a useful range. This eliminates the need for multiple sprockets and derailleur mechanisms, or internal gear hubs, as used on conventional rotary-pedal bicycles.

These and other aspects of the invention are discussed in greater detail below.

### BRIEF DESCRIPTION OF THE DRAWINGS

FIG. 1 is a side elevational view of an example embodiment of the drive system as incorporated into a bicycle;

FIG. 2 is a perspective view of an example embodiment of the complete drive system operably coupled to a drive wheel, wherein the Figure omits portions of the frame for ease of illustration;

FIG. 3 is a side elevational close-up view of one of the actuator levers, showing the adjustable slider and control cables, as well as a twist-grip controller mounted to the handlebars;

FIG. 4 is a cross-sectional view of the actuator lever of FIG. 3, taken along the line I-I′, and showing the upper and lower channels formed with the actuator lever that support the control cable and the slider.

FIG. 5 is a side elevational close-up view of the lower portion of the frame, showing the attachment of the lower idler pulleys to the frame.

FIG. 6 is an exploded view of the drive hub, including segments of the frame and the actuator levers, illustrating the torsion springs employed between the frame and the actuator levers so that energy can be stored in the torsion springs and returned to the drive system as the actuator levers are reciprocally operated by a user.

The various elements depicted in the drawings are merely representational and are not necessarily drawn to scale. Certain proportions thereof may be exaggerated, while others may be minimized. The drawings are intended to illustrate various implementations of the invention, which can be understood and appropriately carried out by those of ordinary skill in the art.

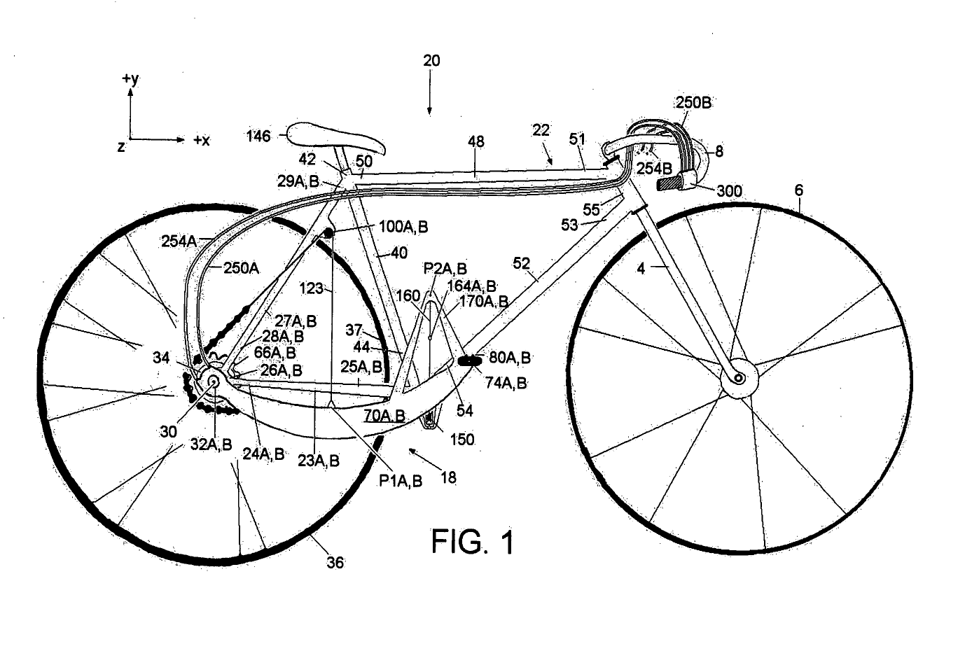

Also, where an element in the Figures has first and second counterparts, and one is hidden by the other, the notation “XA, B” is used. For example, in FIG. 1, the seat stay lower ends 27A and 27B are indicated by “27A, B” where seat stay 27B is hidden by seat stay 27A.

### DETAILED DESCRIPTION OF THE INVENTION

FIG. 1 is a side elevational view of an example embodiment of a muscle-powered drive system (“the drive system”) 18 of the present invention as incorporated into a bicycle 20. An X-Y-Z Cartesian coordinate system is shown in for the sake of reference, wherein “vertical” is in the Y-direction, and horizontal is in the Z- and X-directions. Also, “front” is associated with the +X direction, the “back” is associated with the −X direction, the “top” or “up” is associated with the +Y direction, the “bottom” or “down” is associated with the −Y direction, the right-hand side is associated with the +Z direction, and the left-hand side is associated with the −Z direction. Also, “horizontal” means in or substantially in the X-Z plane, while “vertical” means in or substantially in the Y-Z plane. Thus, “vertical” and “horizontal” are intended to generally indicate relative orientations.

The Frame

Bicycle 20 has a frame 22 that is aligned substantially in the X-Y plane. Bicycle frame 22 is similar to a conventional bicycle frame, e.g., it has a front fork 4 that holds a front wheel 6, and has handlebars 8 that allow for steering the front wheel to guide the bicycle in a desired direction. However, frame 22 includes some modifications as described below.

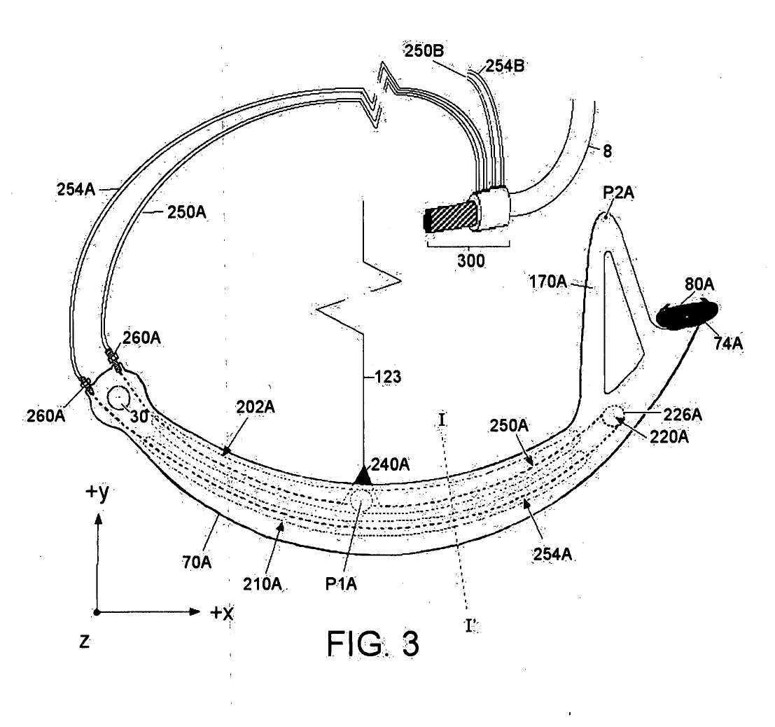

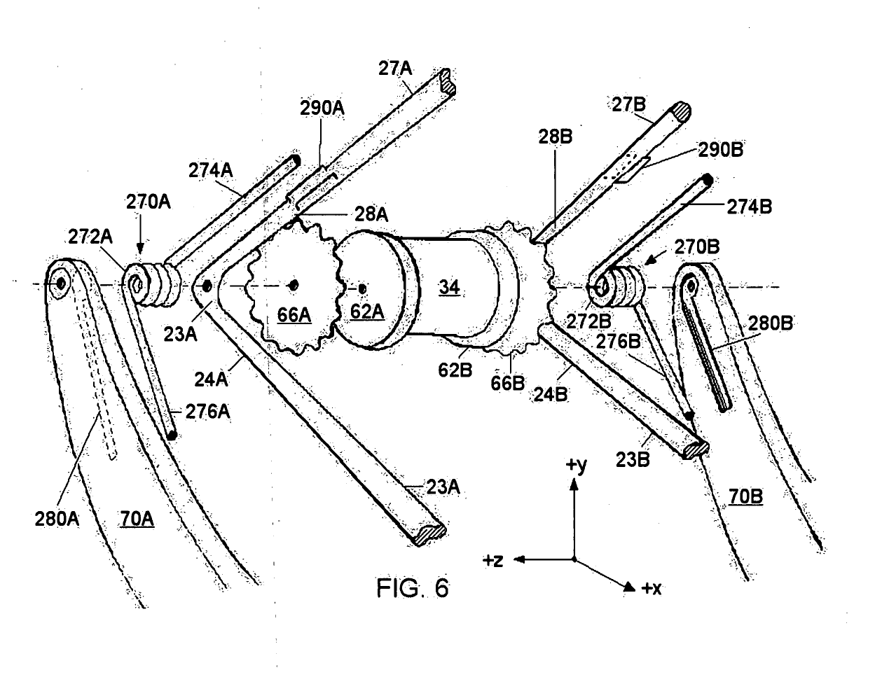

With continuing reference to FIG. 1 (and also to FIG. 6, discussed below), frame 22 includes seat stays 27A and 27B that have corresponding lower ends 28A, 28B and upper ends 29A, 29B, and chain stays 23A and 23B that have corresponding back ends 24A and 24B, and front ends 25A and 25B. Seat stay lower ends 27A and 27B and chain stay back ends 24A and 24B are respectively fixed to axle brackets 26A and 26B, adapted to engage an axle 30 (FIG. 3) of a rear hub 34 of a spoked drive wheel 36 that lies substantially in the X-Y plane. Drive wheel 36 has a front end 37, which remains fixed relative to the frame even when the drive wheel is rotating.

Axle 30 has opposing ends 32A and 32B, arranged on opposite sides of the wheel. Bicycle frame 22 also includes a substantially vertical seat tube 40 having a top end 42 and a bottom end 44. A seat 46 is attached to seat tube top end 42. Seat stay upper ends 29A and 29B are fixed to seat tube 40 at or near top end 42. Chain stay front ends 25A and 25B are fixed to the bottom end 44 of seat tube 40. Frame 22 also includes a top tube 48 having a rearward end 50 and a front end 51. Rearward end 50 is attached to seat tube 40 at or near top end 42. Frame 22 also has a down tube 52 having a front end 53 and rearward end 54 attached at or near the bottom end 44 of seat tube 40. Top tube 48 and down tube 52 are also attached at their respective front ends to a steering head 55, which allows for handlebars 8 to be operably coupled to fork 4 to allow for steering.

The Drive System

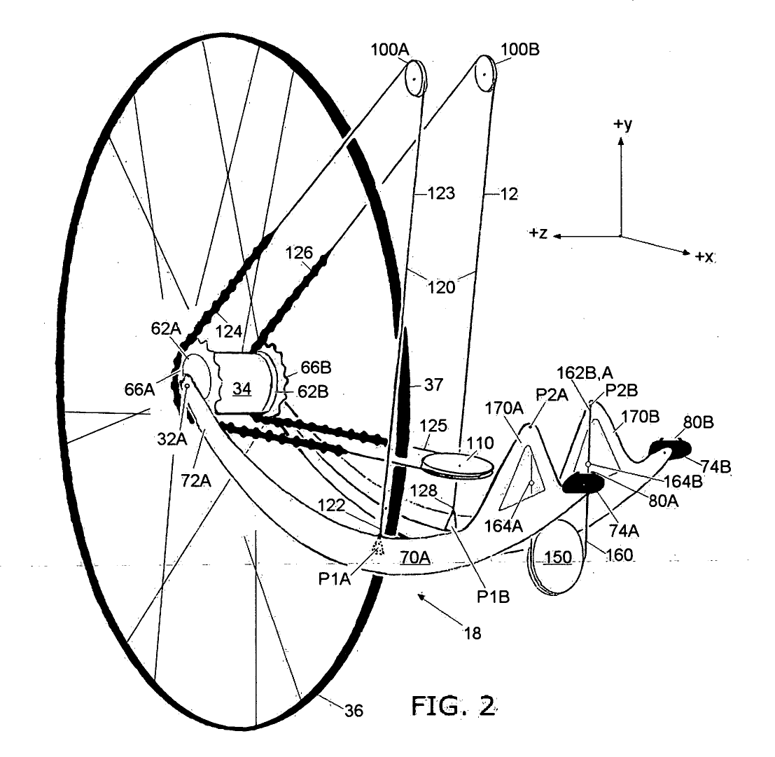

FIG. 2 is a perspective view of the drive system 18 of FIG. 1. FIG. 2 omits portions of the bicycle frame 22 for ease of illustration. The drive system 18 includes the aforementioned rear hub 34, wherein the hub includes left and right mirror-image freewheels 62A and 62B. Two identical left and right sprockets 66A and 66B are affixed to the corresponding left and right freewheels 62A and 62B. Sprockets 66A and 66B are adapted to engage the links of a chain. In an example embodiment, rear hub 34 is fabricated according to one of the industry's standard designs, but is adapted to accommodate two mirror-image freewheels and two sprockets, instead of one of each.

The drive system 18 also includes left and right actuator levers 70A and 70B. The actuator levers have corresponding first ends 72A and 72B each pivotably mounted to frame 22 at or near respective axle brackets 26A and 26B, or alternatively, to axle 30 at or near respective axle ends 32A and 32B. In either embodiment, actuator levers 70A and 70B run from their attachment points essentially in the +X direction on either side of the frame. Actuator levers 70A and 70B also have corresponding movable pedal ends 74A and 74B located at opposite respective pivot ends 72A and 72B.

In an example embodiment, pedal ends 74A and 74B include respective pedals 80A and 80B (e.g., step-in bindings) adapted to accommodate the respective left and right feet of a user (not shown) of the bicycle when the user sits on seat 46. Thus, in an example embodiment, pedal surfaces 80A and 80B occupy approximately the same location as the pedals of a conventional rotary-pedal bicycle, when such pedals are at their forwardmost position of rotation. In an example embodiment, actuator levers 70A and 70B are curved. Actuator levers 70A and 70B are discussed in greater detail below.

The drive system further includes two upper idler pulleys 100A and 100B attached to frame 22, e.g., to respective seat stays 27A and 27B at or near ends 29A and 29B so that the idler pulleys reside above the corresponding actuator levers 70A and 70B and substantially parallel to the X-Y plane with their corresponding actuator levers and sprockets 66A and 66B. The Idler pulleys 100A and 100B themselves are arranged to operate substantially parallel to the X-Y plane.

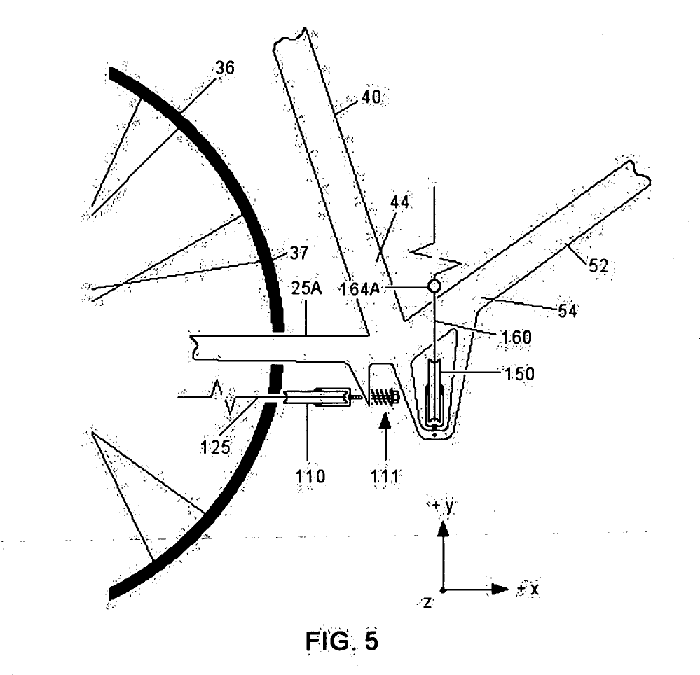

With reference also to FIG. 5, the drive system also includes a center idler pulley 110 attached below chain stay front ends 25A and 25B near the bottom end 44 of seat tube 40, which operates substantially parallel to the X-Z plane. A threaded adjuster/spring tensioner 111 (shown in FIG. 5) is incorporated in the mounting for idler pulley 110, to ensure constant tension and to adjust out any slack in the tether system.

The drive system also includes a drive tether 120 that mechanically couples actuator levers 70 to sprockets 66. In an example embodiment, drive tether 120 is contiguous and includes a first end 122, a first cable section 123, a first chain section 124, a second cable section 125, a second chain section 126, a third cable section 127 and a second end 128. In an example embodiment, the cable sections 123, 125 and 127 are fabricated of stranded round steel cable, and are connected to the first and second chain section, e.g., via swaged devises (not shown).

First tether end 122 is coupled to actuator lever 70A at an adjustable coupling point P1A in between actuator lever ends 72A and 74A. The adjustability of coupling point P1A (and corresponding point P1B on the other actuator lever) is discussed in greater detail below. The first cable section 123 of the tether then runs up from point P1A to and over the top of idler pulley 100A from front to back. The tether then runs down around the corresponding sprocket 66A so that the first chain section 124 engages the back side of this sprocket. The second cable section 125 of the tether 120 then runs forward to center idler pulley 110 along one side of the wheel, around the front part of the center idler pulley, and then back along the other side of the wheel to sprocket 66B, where the second chain section 126 engages the back side of this sprocket. The third cable section 127 then runs back up to the remaining idler pulley 100B, passes over this pulley from back to front, and then extends down to the remaining actuator lever, where the second tether end 128 is fixed at an adjustable point P1B corresponding to adjustable point P1A on the other actuator lever. As discussed above, tensioner 111 is used to provide constant tension and to remove slack in the tether system.

In an example embodiment, the drive system further includes a lever idler pulley 150 rotatably and pivotably fixed to the frame near the bottom end 44 of seat tube 40 (see FIG. 5). In an example embodiment, lever (or “lower”) idler pulley 150 is positioned below and between the two actuator levers and is oriented substantially parallel to the Y-Z plane. A coupling tether 160 is operatively engaged with pulley 150 and has respective ends 162A and 162B fixed to respective positions P2A and P2B on the respective actuator levers 70A and 70B. Tether 160 runs around the bottom side of lever idler pulley 150 through or under the bottom portion of the frame so as to mechanically couple actuator levers 70A and 70B. In an example embodiment, actuator levers 70A and 70B each include an upward extension 170A and 170B to provide for elevated attachment points P2A and P2B for ends 162A and 162B of coupling tether 160. Elevated attachment points P2A and P2B allow lever idler pulley 150 to be positioned to provide adequate ground clearance. In an example embodiment, travel-limiting stops 164A and 164B are affixed to tether 160 and positioned to mechanically limit the range of motion of the actuator levers to ergonomically appropriate parameters.

Method of Operation

In the operation of example drive system 18 in propelling bicycle 20, a user first positions himself or herself on seat 46 of the bicycle and engages their feet with pedal step-in bindings 80A and 80B. Using their leg muscles, the user applies a downward force to one of the pedal surfaces—say, pedal 80A. This downward force causes actuator lever 70A to rotate downwardly about pivot ends 72A and 72B, which pulls the drive tether end 122 downward. This causes the first chain section 124 to drive sprocket 66A in the clockwise direction, which causes wheel 36 to rotate and move bicycle 20 forward. During the downward motion of actuator lever 70A, actuator lever 70B moves upward and into position for the user to apply a downward force thereto.

When actuator lever 70A reaches its limit of motion established by travel-limiting stop 164A, the user applies a downward force to pedal 80B with the opposite leg, causing actuator lever 70B to move downwardly, which pulls the drive tether end 128 downward. This causes the second chain section 126 to drive sprocket 66B in the clockwise direction, which causes wheel 36 to rotate and move bicycle 20 forward. During the downward motion of actuator lever 70B, actuator lever 70A moves upward and into position for the user to apply a downward force thereto.

The process of sequentially applying downward force to pedals 80A and 80B is repeated to provide continual drive power to the drive wheel. Through the use of industry-standard step-in (or “clipless”) binding-type pedals, which removably couple the user's footwear to the actuator levers, power may also be applied on the upward stroke of each actuator lever in combination with the downward stroke on the opposite lever. This is because coupling tether 160 and lever idler pulley serve to couple the upward motion of one actuator lever with the downward motion of the other actuator lever.

It will be observed that the operator need not fully depress the pedal levers to their limits of travel established by stops 164A and 164B, but may instead choose to reverse their directions of travel after only partial strokes. Partial strokes may be useful, for instance, to avoid contact of the pedals with obstacles on the ground, or when performing a banked turn, while maintaining the continuous application of power to the drive wheel.

Continuously Variable Transmission

The range of motion of first and second chain segments 124 and 126 around corresponding sprockets 66A and 66B relative to the reciprocating motion of the actuator levers can be changed over a continuous range, depending on how far away adjustable coupling points P1A and P1B are from respective pivot ends 72A and 72B of respective actuator levers 70A and 70B. If points P1A and P1B are relatively close to corresponding pivot ends 72A and 72B, the drive system is in a ‘low gear’ due to the torque multiplication over the actuator levers' length. Low gears are typically used when a user wishes to exert more force per unit of distance traveled, such as for hill climbing. If points P1A and P1B are moved farther from pivot ends 72A and 72B and more toward pedals 74A and 74B, the drive system is in a ‘high gear’ and the user can provide more force to the drive wheel, such when the user desires higher-speed riding. Of course, in the present invention, there is no quantized changing of discrete gears, as in a conventional bicycle. Rather, the “gear change” is accomplished along a continuum, by changing the leverage applied to the sprockets through the drive tether. This constitutes a continuously variable transmission for the drive system.

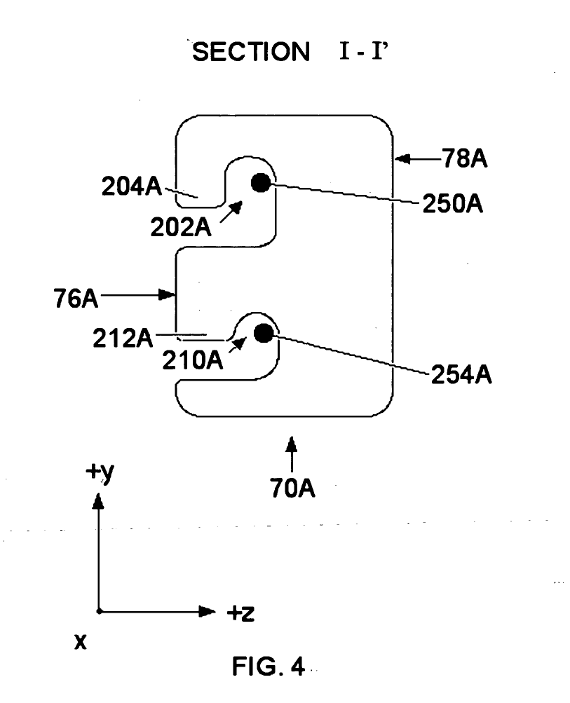

FIG. 3 is a close-up side elevational view of an example embodiment of actuator lever 70A. Also shown in FIG. 3 is first cable section 123 of drive tether 120, and twistgrip controller 300 located, for example, on handlebars 8. FIG. 4 is a cross-sectional view of actuator lever 70A of FIG. 3 taken along the line I-I′. Actuator lever 70A includes an inside surface 76A and an outside surface 78A. Formed on the inside surface 76A is an upper channel 202A that has a lip 204A, and a lower channel 210A with a lip 212A. Channels 202A and 210A run along the length of actuator lever 70A from pivot end 72A to a point 220A near pedal end 74A. A ball-bearing end pulley 226A is located at point 220A and has a diameter roughly that of the separation between the upper and lower channels.

Attached to drive tether end 122 is a slider 240A sized to fit within channel 202A and slide therein. In an example embodiment, slider 240A includes a wheel or other type of rolling member. Lip 204A holds slider 240A within channel 202A. Coupled to the slider is a first push-pull control cable 250A that resides within channel 202A. Also coupled to slider 240A is a second push-pull control cable 254A that resides within channel 210, passes over end pulley 226A and connects up with the slider in channel 202A. First push-pull cable 250A is coupled to channel 202A at pivot end 72A, and second push-pull cable 254A is coupled to channel 210A also at pivot end 72A using standard adjustable threaded cable couplers 260A. A twistgrip hand controller 300 is operably coupled to the push-pull cables 250A and 254A and is adapted to control the length of the control cables via a twisting motion initiated by the user.

In operation, push-pull cables 250A and 254A are adjusted simultaneously with corresponding cables 250B and 254B via the user using twistgrip controller 300 to move the sliders 240A and 240B to a desired pair of coupling positions P1A and P1B along the length of actuator levers 70A and 70B. In an example embodiment, actuator lever 70A and upper and lower channels 250A and 254A are curved so that slider 240A travels over an arc, the center of which is located at or near upper idler pulley 110A. Aside from the twistgrip controller 300, the entire drive system 18, including the above-described gearing system and method, is bilaterally symmetric. Threaded adjusters 260A facilitate installation of the control cables and eliminate slack. End pulley 226A minimizes friction when moving slider 240 to change gear ratios.

Thus, the ‘gearing’ or lever-motion-to-wheel-motion ratio of the drive system is continuously adjustable over a useful range without the need for internal gear hubs, derailleurs and/or multiple-sprocket systems.

Torsion Spring Embodiment

FIG. 6 is an expanded perspective view of the rear-wheel hub 34, sprockets 66A and 66B, freewheel devices 62A and 62B, pedal levers 70A and 70B, and the lower, rear sections of the frame: 24A, 26A, 28A, and 24B and 28B (26B not shown). FIG. 6 also an example embodiment that includes torsion springs 270A and 270B. Torsion springs 270A and 270B have respective coiled sections 272A, 272B, and respective linear extensions 274A, 276A and 276A, 276B that extend from opposite ends of each coiled section. The linear extensions for each torsion spring form an angle roughly equal to the angle formed by the seat stays 27A, 27B and chain stays 23A and 23B at the point where seat stay ends 28A, 28B intersect respective chain stay ends 24A, 24B.

Respective grooves 280A and 280B sized to accommodate a portion of respective coiled sections 272A, 272B and respective extensions 276A, 276B are formed in the inner surfaces 76A and 76B of respective actuator levers 70A and 70B at or near respective actuator lever ends 72A and 72B. Also, seat stays 27A and 27B include respective engaging members 290A and 290B formed at respective seat stay ends 28A and 28B. Engaging members 290A and 290B are adapted to engage a portion of respective torsion spring extensions 274A and 274B. T

When torsion springs 270A and 270B are properly situated in respective grooves 280A and 280B and also held by engaging members 290A and 290B, they are able to store energy when actuator levers 70A and 70B move so as to reduce the angle between torsion spring extensions 274A and 276A, thus compressing the torsion springs. Energy is returned to the drive system as the direction of travel for each actuator lever is reversed and releases the compression on the respective torsion spring, thus providing additional drive power.

It will be understood by those skilled in the art that alternative configurations of frame, seat, wheels, and mounting points for the actuator levers may be accommodated through placement of pulleys in addition to those shown and described in the above preferred embodiment, and that many other apparatus from boats to potter's wheels may advantageously be powered by similar means.

Accordingly, in the foregoing Detailed Description, various features are grouped together in various example embodiments, or shown separately, for ease of understanding. The many features and advantages of the present invention are apparent from the detailed specification, and, thus, it is intended by the appended claims to cover all such features and advantages of the described apparatus that follow the true spirit and scope of the invention. Furthermore, since numerous modifications and changes will readily occur to those of skill in the art, it is not desired to limit the invention to the exact construction and operation described herein. Accordingly, other embodiments are within the scope of the appended claims.

What is claimed is:

1. A drive system for an apparatus having a drive wheel with an axle, a hub and first and second axially mounted sprockets operably attached to the hub, the drive wheel being supported by a frame and powered by a user's limbs, the system comprising:
first and second horizontally arranged pivotable actuator levers having movable pedal ends arranged to be engaged by the user's limbs;
a drive tether having first and second ends movably attached to respective first and second actuator levers, the drive tether having first and second chain sections; and
three idler pulleys mounted to the frame and arranged to engage the drive tether such that the first and second chain sections engage respective rear portions of the first and second sprockets so that reciprocal actuation of the first and second actuator levers by the user's limbs causes force to be delivered from the actuator levers to the drive wheel.

2. The drive system of claim 1, wherein the system is driven by a user's legs.

3. The drive system of claim 1, including a coupling tether attached to first and second actuator levers and that passes through a fourth idler pulley attached to the frame between the actuator levers so as to couple the actuation of the actuator levers when either is lifted;

4. The drive system of claim 3, further including stops fixed to the coupling tether and that impinge the fourth idler pulley to limit a range of arcuate motion of the first and second pedal ends.

5. The drive system of claim 1, wherein:
the drive tether includes first and second end portions and a central cable portion between the chain segments; and
the three idler pulleys include first and second upper idler pulleys amounted to the frame above the respective first and second actuator levers so as to lie in a vertical plane and a central idler pulley mounted to the frame between the actuator levers so as to lie in a horizontal plane; and
the first and second drive tether end portions run vertically from the first and second actuator levers to the respective first and second upper idler pulleys, and the central cable portion runs horizontally around the central idler pulley.

6. The drive system of claim 1, wherein the first and second ends of the drive tether are attached to respective first and second slider elements adapted to controllably move along the length of the respective first and second actuator levers and be set at select positions along said length to adjust the amount of force deliverable to the drive wheel via the actuator levers.

7. The drive system of claim 1, wherein the first and second actuator levers have respective ends opposite the first and second pedal ends that are pivotably mounted to the frame at or near the drive wheel axle.

8. The drive system of claim 1, wherein the frame is a bicycle frame.

9. The drive system of claim 1, wherein the first and second actuator levers have respective first and second pivotable ends opposite the first and second movable pedal ends, and including:
first and second torsion springs fixed to the frame and to the first and second actuator levers at or near the respective first and second pivotable ends such that each torsion spring alternately stores energy and releases the energy to the drive wheel when the actuator levers are reciprocally actuated.

10. A drive system powered by a user's limbs, comprising:
a frame;
a drive wheel supported by the frame and that includes an axle and first and second sprockets operably coupled to the drive wheel;
first and second horizontally arranged actuator levers pivotably mounted at respective first ends to either the frame or the axle, and having respective second pedal ends opposite the first ends that are movable in an arc centered on the pivotably mounted first ends, the pedal ends arranged to be engaged by the user's limbs;
three idler pulleys attached to the frame; and
a drive tether attached to the respective first and second actuator levers and that is engaged by the three idler pulleys so that first and second chain sections of the drive tether engage respective rear portions of the first and second sprockets, respectively, so that movement of the pedal ends transfers drive power to the drive wheel via the drive tether.

11. The drive system of claim 10, wherein the drive system is powered by a user's legs.

12. The drive system of claim 10, wherein the drive tether has first and second ends attached to the respective first and second actuator levers at coupling points P1A and P1B, and wherein the coupling points P1A and P1B can be moved to different positions along a length of the corresponding actuator levers.

13. A bicycle powerable by a user, comprising:
a frame with a front fork that supports a front wheel;
a rear drive wheel operably attached to the frame and having front end and a hub with first and second sprockets;
a seat supported by the frame and adapted to support the user;
first and second horizontally oriented actuator levers having respective pivot ends mounted to either the drive wheel axle or the frame near the drive wheel axle, and having movable pedal ends arranged to engage feet of the user when the user sits upon the seat;
a drive tether having first and second ends respectively attached to the first and second actuator levers at respective adjustable coupling points P1A and P1B, the drive tether having first and second chain sections that operably engage respective rear portions of first and second sprockets on the drive wheel;
first and second idler pulleys attached to an upper portion of the frame and a central idler pulley attached to the frame adjacent a front end of the drive wheel, the idler pulleys adapted to engage the drive tether; and
wherein reciprocal movement of the pedal ends initiated by the user transfers power from the actuator levers to the drive wheel via the drive tether.

14. The bicycle of claim 13, wherein the bicycle includes means for adjusting respective positions of coupling points P1A and P1B along a length of each actuator lever.

15. The bicycle of claim 13, wherein the drive tether includes a portion that runs horizontally on either side of the drive wheel and that also runs around the front end of the drive wheel.

16. The bicycle of claim 13, including a coupling tether attached to the first and second actuator levers and that passes through a fourth idler pulley attached to the frame between the actuator levers so as to couple the reciprocal actuation of the actuator levers when either is lifted.

17. The bicycle of claim 13, further including first and second spring means for storing energy and releasing energy back to the drive wheel during reciprocal actuation of the actuator levers.
